(19) United States
(12) Patent Application Publication
(10) Pub. No.: US 2024/0160553 A1
(43) Pub. Date: May 16, 2024

(54) QUALITY OF SERVICE MANAGEMENT IN A MEMORY SUB-SYSTEM

(71) Applicant: MICRON TECHNOLOGY, INC., Boise, ID (US)

(72) Inventors: Raja V.S. Halaharivi, Gilroy, CA (US); Prateek Sharma, San Jose, CA (US); Horia C. Simionescu, Foster City, CA (US)

(21) Appl. No.: 18/388,610

(22) Filed: Nov. 10, 2023

Related U.S. Application Data
(60) Provisional application No. 63/425,448, filed on Nov. 15, 2022.

(51) Int. Cl. G06F 11/34

(52) U.S. Cl. CPC G06F 11/3428

(57) ABSTRACT

A memory system includes a memory device and a processing device coupled to the memory device, the processing device is to present a plurality of physical or virtual functions (PFs/VFs) to a host computing system; set, for each of the plurality of PFs/VFs, a value of a credit counter to an initial value associated with a Quality of Service (QoS) parameter of a respective PF/VF; responsive to fetching an original command received from the host computing system associated with a specified PF/VF, decrement the value of the credit counter associated with the specified PF/VF; responsive to receiving a reintroduced command associated with the specified PF/VF after the original command, increment the value of the credit counter; determine whether the value of the credit counter is not higher than a threshold value; and responsive to determining that the value of the credit counter is higher than the threshold value, continue fetching a subsequent command associated with the specified PF/VF.

### RELATED APPLICATIONS

This application claims the benefit of U.S. Provisional Patent Application No. 63/425,448, filed Nov. 15, 2022, the entire contents of which are incorporated by reference herein.

### TECHNICAL FIELD

Embodiments of the disclosure relate generally to memory sub-systems, and more specifically, relate to quality of service (QoS) management in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system in accordance with some embodiments of the present disclosure.

FIG. 2 illustrates an example QoS management component included in a memory sub-system in accordance with some embodiments of the present disclosure.

FIG. 3 illustrates a QoS management component including multiple credit counters in a memory sub-system in accordance with some embodiments of the present disclosure.

FIG. 4 illustrates a physical controller implementing a QoS management component in accordance with some embodiments of the present disclosure.

FIGS. 5-6 are flow diagrams of example methods to manage QoS per physical function or virtual function in a memory sub-system in accordance with some embodiments of the present disclosure.

FIG. 7 is a block diagram of an example computer system in which embodiments of the present disclosure can operate.

### DETAILED DESCRIPTION

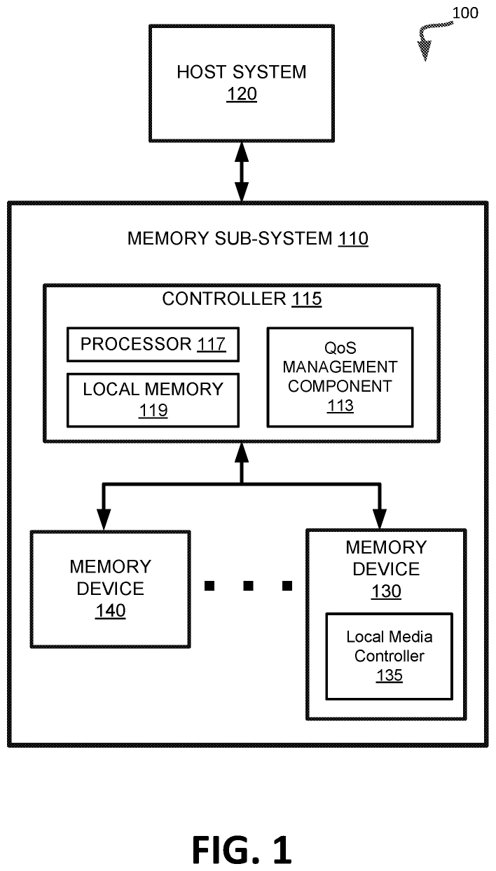

Aspects of the present disclosure are directed to quality of service (QoS) management in a memory sub-system. A memory sub-system can be a storage device, a memory module, or a combination of a storage device and memory module. Examples of storage devices and memory modules are described below in conjunction with FIG. 1. An example of a memory sub-system is a storage device that is coupled to a central processing unit (CPU) via a peripheral interconnect (e.g., an input/output bus, a storage area network). Examples of storage devices include a solid-state drive (SSD), a flash drive, a universal serial bus (USB) flash drive, and a hard disk drive (HDD). Another example of a memory sub-system is a memory module that is coupled to the CPU via a memory bus. Examples of memory modules include a dual in-line memory module (DIMM), a small outline DIMM (SO-DIMM), a non-volatile dual in-line memory module (NVDIMM), etc. In some embodiments, the memory sub-system can be a hybrid memory/storage sub-system. In general, a host system can utilize a memory sub-system that includes one or more memory components. The host system can provide data to be stored at the memory sub-system and can request data to be retrieved from the memory sub-system.

A memory sub-system can include high density non-volatile memory devices where retention of data is desired when no power is supplied to the memory device. One example of a non-volatile memory device is a NAND memory device, such as 3D flash NAND memory, which offers storage in the form of compact, high density configurations. Other examples of non-volatile memory devices are described below in conjunction with FIG. 1. A non-volatile memory device is a package of one or more die. Each die can include one or more planes. For some types of non-volatile memory devices (e.g., NAND memory devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types.

Memory access commands, such as those sent by the host system, request the memory sub-system to perform memory access operations on the memory devices of the memory sub-system. Memory access commands can generally be classified into respective categories, such as read commands, write commands, erase commands, move commands, etc. A memory sub-system controller can receive the memory access commands from the host system connected externally to the memory sub-system, such as via a Non-Volatile Memory Express (NVMe) interface on a Peripheral Component Interconnect Express (PCIe) communication bus. The memory sub-system can execute the memory access commands to perform the memory access operations and return the results of executing the memory access commands to the host system via the host interface.

The memory sub-system can present to the host system one or more physical functions over the PCIe interface. A physical function may represent a partitioned part of a memory sub-system that is attached to a given host system. A memory sub-system can be partitioned into multiple subsystems by using multiple physical functions. In some systems, the memory sub-systems utilize a specification that allows the isolation of PCIe resources among various hardware functions for manageability and performance reasons, while also allowing single physical PCIe devices to be shared in a virtual environment. A physical function allows enumeration of a number of virtual functions and a hypervisor can then assign those virtual functions to one or more virtual machines.

In certain implementations, the host system controller can utilize a set of queues to manage the memory access commands issued to a physical function presented by the memory sub-system. For example, the host system can maintain multiple submission queues, such that each submission queue stores a set of submission queue entries representing the memory access commands issued to the memory sub-system. In certain implementations, a memory sub-system controller can use an arbiter component to arbitrate and select queues and commands for further processing by other components of the memory sub-system controller. The arbiter component can include control logic and the multiple submission queues to provide an order of accesses for data requested. In certain implementations, the arbiter component can determine, according to an arbitration scheme, when to execute requests and fill operations. For example, the arbiter component can implement a round-robin scheme. In such memory devices, each read and/or write command is placed into one of a set of queues. The memory sub-system controller can fetch a command from each queue in a round-robin fashion, e.g., a first command is fetched from queue “0”, a second command is fetched from queue “1”, a third command is fetched from queue “2”, etc. However, the quality of service (QoS) (e.g., by bandwidth, input/output operations per second (IOPS)) for physical function, virtual function, or queue is not managed.

Aspects of the present disclosure address the above and other deficiencies by implementing a memory sub-system that maintains a quality of service (QoS) parameter per physical function, virtual function, or queue. The QoS parameter can facilitate consistent bandwidth and predictable latency to input/output (I/O) streams. Examples of QoS parameter includes bandwidth, input/output operations per second (IOPS), or other characteristics.

Using the physical or virtual function as an example, the memory sub-system can maintain a dedicated credit counter for each physical or virtual function. The memory sub-system can set an initial value to the credit counter at the beginning of a time window. The time window may refer to a duration (e.g., 10 μs, 10 ms) that a credit counter will function constantly before a value thereof being reset. The initial value may reflect a maximum allowable value of a QoS parameter (e.g., 14 GB/s bandwidth, or 3 M/s IOPS) for the specific physical or virtual function. The initial value may vary depending on the time window. The credit counter is decremented each time an original command, from a host system, associated with the physical or virtual function is fetched from a queue and incremented each time a reintroduced command, from a firmware component of the memory sub-system, associated with the physical or virtual function is received. An original command refers to a command received from a host system. A reintroduced command refers to a command outputting from the firmware component of the memory sub-system, where the firmware component processes the original command for QoS. In some implementations, the reintroduced command can be the same to the original command or slightly modified version of the original command. For example, the original command can be a NVMe I/O command sent by a host system. The reintroduced command can be the exact same as the original NVMe command after the original NVMe command being pre-processed for QoS. In another example, the reintroduced command can be a modified NVMe command to fit into the memory sub-system using an internal opcode with a link to the original NVMe command, and once this reintroduced command is executed through the memory sub-system, the firmware component can send a completion signal linked to the original command received from the host system. The memory sub-system controller can monitor the credit counter for each physical or virtual function to enable the memory sub-system to take actions regarding a usage control of QoS parameter for each physical or virtual function. This setup allows the firmware component of the memory sub-system providing a user specific QoS control per physical or virtual function by using the credit counter, which will be described in detail below. The firmware component can validate the original command to provide a QoS control over a physical or virtual function by affecting the value of the credit counter for that physical or virtual function.

Specifically, the firmware component can set a maximum allowable value of a QoS parameter for a physical or virtual function by assigning an initial value to the credit counter. In one example, the initial value is calculated by dividing the allowable value of the QoS parameter for the physical or virtual function (e.g., 14 GB/s bandwidth) by a capacity unit of the QoS parameter (e.g., 128 kB/s bandwidth). The capacity unit of the QoS parameter may refer to an undividable unit of the QoS parameter, an industry-standard unit of the QoS parameter, or a customized unit of the QoS parameter.

After the initial value of the credit counter is set, the memory sub-system decrements the value of the respective credit counter by a specific value upon which an original command is fetched from a queue of the physical or virtual function. The specific decrement value (i.e., the value by which the counter is decremented) may depend on the size of the original command with respect to the QoS parameter. In one example, the decrement value is calculated by dividing the size of the command with respect to the QoS parameter (e.g., a command using 128 kB/s bandwidth) by the capacity unit of the QoS parameter (e.g., 128 kB/s bandwidth).

The memory sub-system can send the original command to the firmware component to assess its effect over the QoS parameter of the physical or virtual function, and receive the feedback, from the firmware component, which reflects the assessing result. The feedback can indicate whether the original command is in fact consuming the capacity of the QoS parameter indicated in the decrement value of the credit counter of the physical or virtual function, and if not, how much capacity of the QoS parameter is actually not used, and thus, a corresponding value can be given back (i.e., increment) to the credit counter of the physical or virtual function. This can happen, for example, when the original command is an administrative command but not an I/O command, and thus, the original command is not consuming the capacity of the QoS parameter in the physical or virtual function. To give back the value of the credit counter, the feedback may include a reintroduced command, where the size of the reintroduced command with respect to QoS parameter can indicate the value of the credit counter to be incremented. In one example, the specific increment value (i.e., the value by which the counter is incremented) is calculated by dividing the size of the reintroduced command with respect to the QoS parameter (e.g., a reintroduced command using 128 kB/s bandwidth) by the capacity unit of the QoS parameter (e.g., 128 kB/s bandwidth).

The memory sub-system can set a threshold value indicative of the time when the value usage of the QoS parameter in the physical or virtual function reaches its allowable value of the QoS parameter, and thus, to enable the memory sub-system to take corresponding actions. Accordingly, responsive to determining that the credit counter has not reached the threshold value, the memory sub-system can continue fetching future commands associated with the physical or virtual function; and responsive to determining that the credit counter has reached the threshold value, the memory sub-system can stop fetching future commands associated with the physical or virtual function. The memory sub-system may resume fetching future commands associated with the physical or virtual function when the credit counter has changed to a value that does not reach the threshold value anymore, for example, the value of the credit counter has been reset to its initial value at the beginning of a subsequent time window.

In some implementations, the value of the credit counter can be reset by the firmware component (e.g., at a pre-determined frequency using the time window). In some implementations, the value of the credit counter can be adjusted (e.g., in real time) to a specific value by the firmware component. As such, by using the credit counter, the firmware component can control the QoS per physical or virtual function dynamically.

Although the physical or virtual function is used as an example, the physical function, the virtual function, queue, or any combination thereof can be applicable to the present disclosure. Also, although a QoS control of a single physical or virtual function is illustrated, any granularity including a set of physical functions, a set of virtual functions, a set of queues can be applicable to the present disclosure. For example, a physical function may include multiple virtual functions, a credit counter can be configured to each virtual function, and thus, the QoS control is specific to each virtual function. In another example, a credit counter can be configured to a set of queues, which may or may not correspond to a physical function, and the QoS control is specific to the set of queues.

Advantages of the present disclosure include improved performance by taking advantage of the entire bandwidth between the host system and the memory sub-system and by implementing QoS control specific to each physical or virtual function, and improved adaptability by allowing the runtime workload to dynamically adjust based on the QoS management. Thus, aspects of the present disclosure further improve performance and quality of service of the memory sub-system. For example, traditionally, in some cases when the memory access command is fetched from the host system, the memory sub-system does not guarantee the QoS of the physical or virtual functions, and in some cases when the bandwidth is in its full capacity, the memory access command that has been fetched cannot be processed. In another example, traditionally, in some cases when the IOPS reaches its limit, the memory access command that has been fetched also cannot be processed. Thus, the memory sub-system traditionally does not take full advantage of the quality of service management scheme of the host system. Aspects of the present disclosure provide adaptability by allowing a QoS control specific to each of multiple physical or virtual function. The system can specify the QoS parameter limit for each physical or virtual function. Aspects of the present disclosure provide fairness in the QoS control to each physical or virtual functions that use memory resources.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non- volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processors.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a QoS management component 113 that is capable of managing QoS for each physical or virtual function. In some embodiments, the controller 115 includes at least a portion of the QoS management component 113. For example, the controller 115 can include a processor 117 (processing device) configured to execute instructions stored in local memory 119 for performing the operations described herein. In some embodiments, some of the functionality of the QoS management component 113 can be implemented as part of the processor 117, as part of firmware on the controller 115, as part of an application or an operating system executing on the processor 117. Alternatively, some of the functionality of the QoS management component 113 can be implemented as part of the host system 120.

The QoS management component 113 can configure a credit counter for each of the PFs/VFs and set an initial value to the credit counter. Responsive to fetching, by the controller 115, an original command received from the host system 120 from a queue associated with a physical or virtual function, the QoS management component 113 can decrement the value of the credit counter based on the size of the original command associated with the QoS parameter. A firmware component (not shown) of the memory sub-system 110 can process the original command to generate a feedback regarding the QoS parameter of the physical or virtual function. Responsive to receiving the feedback, the QoS management component 113 may increment or not, based on the feedback, the value of the credit counter.

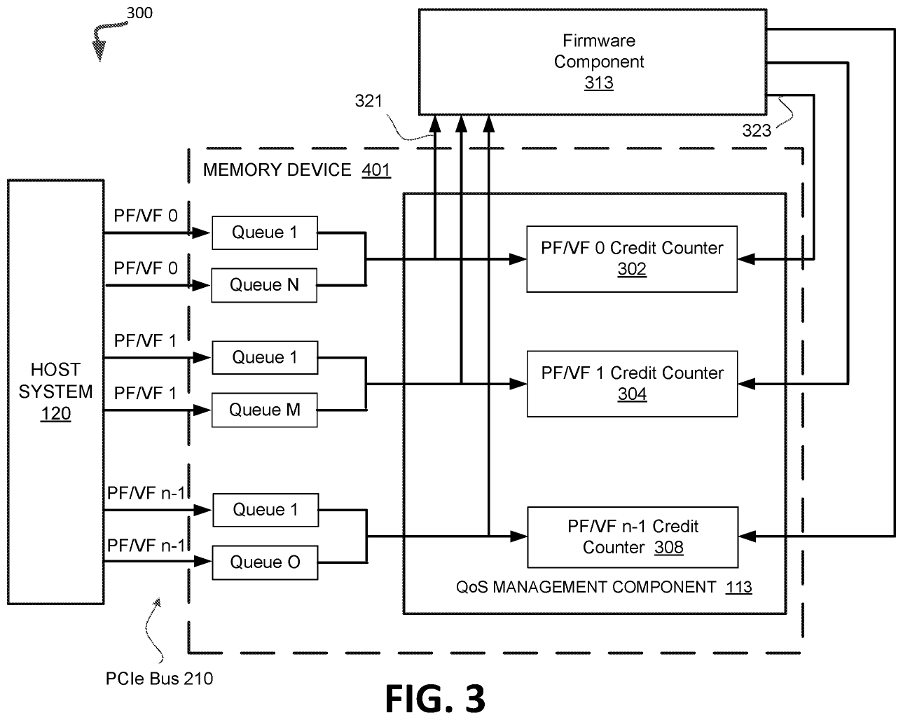

The controller 115 can use the QoS management component 113 to determine whether the value of the credit counter has reached a threshold value. Responsive to determining that the value of the credit counter has reached the threshold value, the controller 115 may stop fetching the subsequent command associated with the physical or virtual function until it is determined that the value of the credit counter no longer reaches the threshold value. Additional details of the QoS management component 113 are described with respect to FIG. 3.

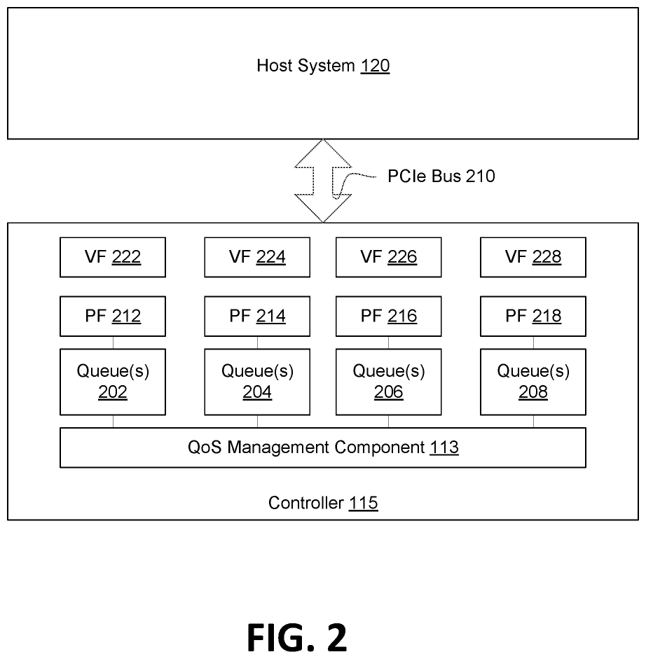

FIG. 2 illustrates an example QoS management component 113 in accordance with some embodiments of the present disclosure. In one embodiment, the controller 115 of memory sub-system 110 is connected to host system 120 over a physical host interface, such as PCIe bus 210. In one embodiment, the QoS management component 113 can be implemented as part of the controller 115 or as a separate circuit from the controller 115. The controller 115 manages a number of queues 202-208 within the controller 115 and a number of physical functions (PFs) 212-218. Physical functions 212-218 are fully featured PCIe functions that can be discovered, managed, and manipulated like any other PCIe device, and thus can be used to configure and control a PCIe device (e.g., queues 202-208).

Each physical function 212-218 is a PCI function that supports the virtualization capabilities, and thus physical functions 212-218 can each allow enumeration of a number of virtual functions (VFs). It should be noted that the controller 115 can also manage virtual functions, virtual controllers, or the like to present themselves as physical functions and physical controllers to other devices, such as host system 120, connected to PCIe bus 210 by virtue of the physical function 212-218 associated with each queue 202-208. The virtual functions 222-228 can be lightweight PCIe functions that share one or more resources with one physical function and with virtual functions 222-228 that are associated with that physical function. For example, the PCI configuration space of each virtual function 222-228 can be accessed by a bus, device, and function (BDF) number of the physical function. Each virtual function 222-228 can have a PCI memory space, which is used to map its register set. The virtual function device drivers operate on a register set to enable its functionality and the virtual function appears as an actual PCIe device, accessible by host system 120 over PCIe bus 210.

Although FIG. 2 illustrates four queues 202-208, four corresponding physical functions 212-218, and four virtual functions 222-228, in other embodiments, there may be any other number of queue(s) 202-208, each having a corresponding physical or virtual function. Each queue(s) 202-208 stores commands of corresponding applications on the host system 120 in connection with storage access operations for the corresponding portion of the underlying memory devices, with which it is associated. Each queue(s) 202-208 can receive a command (e.g., data access requests) from host system 120 over PCIe bus 210 via PFs 212-218 or VFs 222-228, respectively, including requests to read, write, or erase data in a portion of memory device 130. The QoS management component 113 can configure a credit counter for each of PFs 212-218 or VFs 222-228 and set an initial value for each credit counter. Responsive to fetching, by the controller 115, an original command received from the host system 120 associated with one of PFs 212-218 or VFs 222-228, the QoS management component 113 can decrement the value of the respective credit counter based on the size of the command associated with the QoS parameter. Responsive to receiving the feedback from the firmware component, the QoS management component 113 may increment or not, based on the feedback, the value of the respective credit counter. The controller 115 can use the QoS management component 113 to determine whether the value of the respective credit counter reaches a threshold value. Responsive to determining that the value of the respective credit counter has reached the threshold value, the controller 115 may stop fetching the subsequent command associated with the respective one of PFs 212-218 or VFs 222-228 until it is determined that the value of respective credit counter no longer reaches the threshold value. Additional details of the QoS management component 113 are described with respect to FIG. 3.

FIG. 3 illustrates a QoS management component including multiple credit counters in a memory sub-system in accordance with some embodiments of the present disclosure. The system 300 can include the host system 120 and one or more memory devices, such as illustrated by the memory device 401. The system 300 may include a system controller (not shown) that is operatively coupled with the memory devices. The system controller can present two or more physical or virtual functions (PFs/VFs) to the host system 120 over an interconnect, such as a PCIe interface. The host system 120 can assign each of the PFs/VFs to individual applications, virtual machines, or the like. The host system 120 can request the number of PFs/VFs needed and the system controller can assign or otherwise associate one or more queues to each of the various PFs/VFs. Each of the queues is associated with a physical or virtual function presented to the host system 120 over the PCIe interface. In some embodiments, each of the PFs/VFs corresponds to a virtual memory controller that is associated with a different portion of the memory devices.

The system 300 includes a QoS management component 113 (e.g., a QoS management circuit). As described herein, the QoS management component 113 can be implemented in hardware as a QoS management circuit implementation. The QoS management component 113 can configure a credit counter for each of the PFs/VFs. In some implementations, the QoS management component 113 can configure a credit counter to multiple PFs/VFs, for example, a set of the PFs/VFs. The credit counter may reflect a usage credit value of a QoS parameter associated with a physical or virtual function. For example, the QoS parameter associated with the physical or virtual function may be the bandwidth that can be used by the physical or virtual function, and the credit counter records the available bandwidth that still can be used by the physical or virtual function, and enables the system 300 to take actions if the available bandwidth (credit) is lower than a threshold value, as described in detail below. In another example, the QoS parameter associated with the physical or virtual function may be the IOPS that can be used by the physical or virtual function, and the credit counter records the available IOPS that still can be used by the physical or virtual function, and enables the system 300 to take actions if the available IOPS (credit) is lower than a threshold value, as described in detail below.

As shown in the example of FIG. 3, the physical or virtual function PF/VF 0 is associated with one or more queues 1-N, the physical or virtual function PF/VF 1 is associated with one or more queues 1-M, and the physical or virtual function PF/VF n-1 is associated with one or more queues 1-O. For each of the physical or virtual functions PF/VF 0, PF/VF 1, PF/VF n-1, the QoS management component 113 configures PF/VF 0 credit counter 302, PF/VF 1 credit counter 304, and PF/VF n-1 credit counter 308, respectively. The QoS management component 113 can generate a vector, a list, or other data structure with a different element for each of the PFs/VFs. For example, the data structure can include a first element in the data structure corresponds to a first PF/VF (PF/VF 0), a second element in the data structure corresponds to a second PF/VF (PF/VF 1), and so forth up to the n^{th} PF/VF (PF/VF n-1).

The QoS management component 113 can set an initial value for each of the credit counters 302, 304, 308. The initial value of the credit counter 302, 304, 308 may be set specific to the physical or virtual function, and thus, various initial values can be applied to various physical or virtual functions. The initial value of the credit counter 302, 304, 308 may be set based on information provided by a firmware component 313. The firmware component 313 can provide allowable value of a QoS parameter in a specific physical or virtual function. The firmware component 313 can thus manage all physical or virtual functions regarding capacity of the QoS parameter so that each physical or virtual function has a fair chance to use the resources and the QoS parameter for each physical or virtual function is under the control.

In some implementations, the firmware component 313 can determine, based on allowable usage information regarding a QoS parameter in a specific physical or virtual function, the number of commands that can be fetched for the specific physical or virtual function, and the QoS management component 113 can set the initial value of the credit counter according to the number of commands for the specific physical or virtual function. For example, the firmware component 313 can determine, based on the allowable bandwidth for the specific physical or virtual function, the number of commands that can be fetched for the specific physical or virtual function. The QoS management component 113 can then set the initial value of the credit counter to be the same as the determined number of commands. In another example, the firmware component 313 can determine, based on the allowable IOPS for the specific physical or virtual function, the number of commands that can be fetched for the specific physical or virtual function. The QoS management component 113 can then set the initial value of the credit counter to be the same as the determined number of commands.

After the initial value has been set, the credit counter can start to record the value dynamically as described below. Responsive to fetching, by the memory device 401, an original command received from the host system 120 associated with a physical or virtual function, the QoS management component 113 can decrement the value of the credit counter based on the size of the original command associated with the QoS parameter. For example, when the command requires “X1” bandwidth (e.g., a command requiring 256 kB/s bandwidth), the QoS management component 113 can decrement the value of the credit counter by a value corresponding to “X1” bandwidth (e.g., the value 1 corresponds to 128 kB/s bandwidth, then 256 kB/s bandwidth corresponds to a value 2); when the command requires “Y1” IOPS (e.g., a command requiring 400 k/s IOPS), the QoS management component 113 can decrement the value of the credit counter by a value corresponding to “Y1” IOPS (e.g., the value 1 corresponds to 100 k/s IOPS, then 400 k/s IOPS corresponds to a value 4).

The original command can be sent to the firmware component 313. The firmware component 313 may process the command to generate the feedback regarding a QoS control. The feedback may include an instruction that indicates whether to increment the value of the credit counter. The QoS management component 113 can receive, from the firmware component 313, the feedback. Responsive to receiving the feedback instructing to increment the value of the credit counter, the QoS management component 113 increments the value of the credit counter specified in the feedback. Responsive to receiving the feedback instructing not to increment the value of the credit counter, the QoS management component 113 does not increment the value of the credit counter.

In some implementations, the feedback can include a reintroduced command that is used to adjust the value of the credit counter. The reintroduced command can have metadata informing the size of the QoS parameter that the reintroduced command requires. In response to receiving the reintroduced command, the QoS management component 113 can increment the value of the credit counter by a value corresponding to the size of the QoS parameter associated with the reintroduced command. For example, when the reintroduced command requires “X2” bandwidth (e.g., a command requiring 128 kB/s bandwidth), the QoS management component 113 can increment the value of the credit counter by a value corresponding to “X2” bandwidth (e.g., the value 1 corresponds to 128 kB/s bandwidth); when the reintroduced command requires “Y2” IOPS (e.g., a command requiring 200 k/s IOPS), the QoS management component 113 can increment the value of the credit counter by a value corresponding “Y2” IOPS (e.g., the value 1 corresponds to 100 k/s IOPS, then 200 k/s IOPS corresponds to a value 2).

The QoS management component 113 can determine whether the value of the credit counter reaches a threshold value. In some implementations, the QoS management component 113 determines whether the value of the credit counter reaches a threshold value at a preset interval. In some implementations, the QoS management component 113 determines whether the value of the credit counter reaches a threshold value each time the value is changed (decremented or incremented).

In some implementations, the value of the credit counter reaches a threshold value when the value of the credit counter is lower than or equals zero (i.e., the value of the credit counter is not higher than zero). In some implementations, the value of the credit counter reaches a threshold value when the value of the credit counter is lower than or equals a preset value (i.e., the value of the credit counter is not higher than the preset value). For example, the preset value may correspond to a usage reminder of the QoS parameter that the system wants to reserve. In another example, the preset value may indicate a size of the QoS parameter that is not enough for a regular command.

In response to determining that the value of the credit counter reaches a threshold value, the QoS management component 113 can indicate the memory device 401 to stop fetching the subsequent command associated with the physical or virtual function until it is determined that the value of credit counter no longer reaches the threshold value. For example, the physical or virtual function can include a bit to indicate that the physical or virtual function has reached the threshold value. In response to determining that the value of the credit counter has not reached the threshold value, QoS management component 113 can indicate the memory device 401 to fetch the subsequent command associated with the physical or virtual function. For example, the physical or virtual function can include a bit to indicate that the physical or virtual function has not reached the threshold value. As such, the QoS management component 113 can determine, for each of the PFs/VFs, whether the QoS limit has been reached.

The QoS control by using the credit counter can work in granularity with a time window. The initial value of the credit counter can be set or reset at the beginning of a time window. In some implementations, the initial value to be set at the beginning of a subsequent time window depends on the value of the credit counter at the end of a previous time window. For example, the value of the credit counter at the end of the previous time window is much lower than the threshold value, which means that a capacity of QoS parameter within the physical or virtual function has been overused, and then the initial value for the subsequent time window can be set as lower as the threshold value, which means that no command associated with the physical or virtual function will be fetched during that time window.

In some implementations, a credit counter can have multiple sets of values each used for different QoS parameters. For example, a credit counter may have a first value used for bandwidth and a second value used for IOPS. For each of first value and second value, the process for decrement and increment can be applied, and when any of the first value and second value reaches to its threshold value (e.g., a first threshold value, a second threshold value, respectively), the QoS management component 113 can indicate the memory device 401 to stop fetching the subsequent command associated with the physical or virtual function until both of the first value and second value no longer reaches to its threshold value. In some implementations, multiple credit counters can be configured to one physical or virtual function, and each credit counter is used for one of multiple QoS parameters associated with that physical or virtual function.

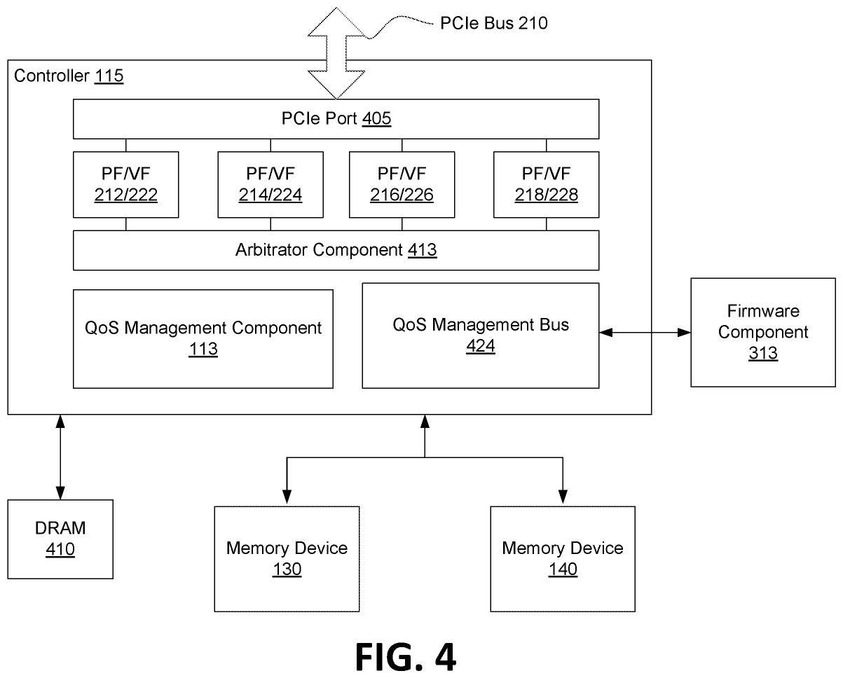

FIG. 4 illustrates a physical controller implementing a QoS management component in accordance with some embodiments of the present disclosure. Controller 115 manages operations of storage media in the memory sub-system 110 including memory devices 130, 140 and optionally volatile memory, such as one or more dynamic random access memory (DRAM) devices 410. Controller 115 includes QoS management component 113 and physical or virtual functions (PFs/VFs) 212-218/222-228. PFs/VFs 212-218/222-228 are coupled to PCIe port 405 which enables communications with host system 120 across PCIe bus 210. In one embodiment, controller 115 further includes an arbitrator component 413. Arbitrator component 413 can arbitrate and select a port within PCIe port 405, a physical or virtual function from PFs/VFs 212-218/222-228, and a queue (not shown) associated with the physical or virtual function to decide which command to fetch.

When the PFs/VFs 212-218/222-228 receive multiple commands to access data in one of memory devices 130, 140, for example, the arbitrator component 413 can select the command and the QoS management component 113 can configure a credit counter for the respective physical or virtual function for monitoring the QoS parameter usage associated with the command as described above. Thus, the QoS management component 113 can implement individual quality of service management for each of the multiple PFs/VFs. When a large storage device, such as one of memory components is sliced into smaller partitions, each controlled by PF/VF, and that can each be used by different clients (e.g., virtual machines on host system 120), it may be beneficial to associate QoS characteristics with each individual partition. To meet these requirements, the QoS management component 113 attaches QoS controls to each PF/VF. The QoS controls may include, for example, an individual storage partition size, bandwidth, or other characteristics. The QoS management component 113 may monitor the performance of queues 202-208 over time and may reconfigure resource assignments as needed to ensure compliance with the QoS requirements.

The controller 115 further includes a QoS management bus 424. The QoS management bus 424 communicates with a firmware component 313 to allow a user specific QoS control. The controller 115 may receive a feedback regarding the user specific QoS control (e.g., a reintroduced command regarding the QoS control associated with the physical or virtual function) via QoS management bus 424.

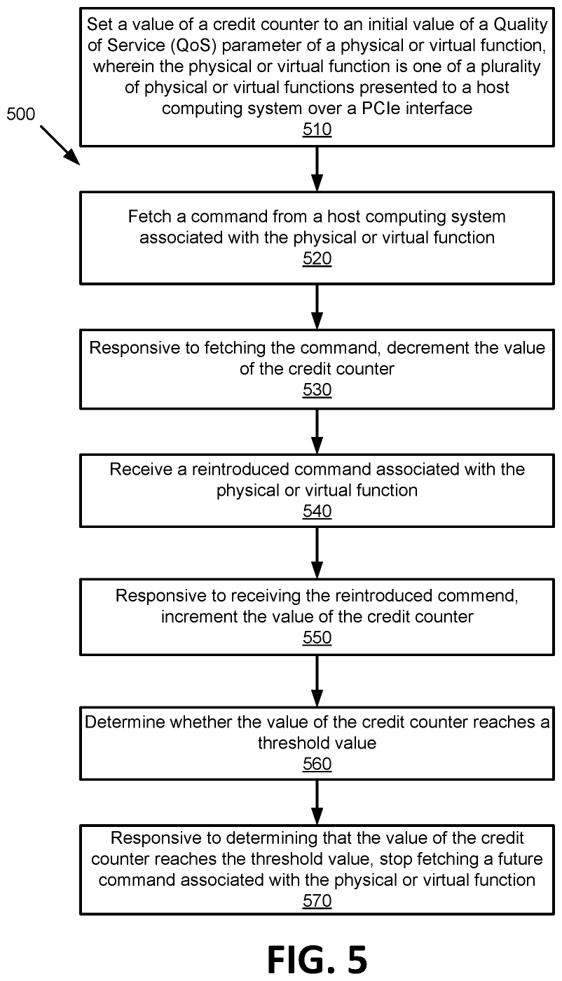

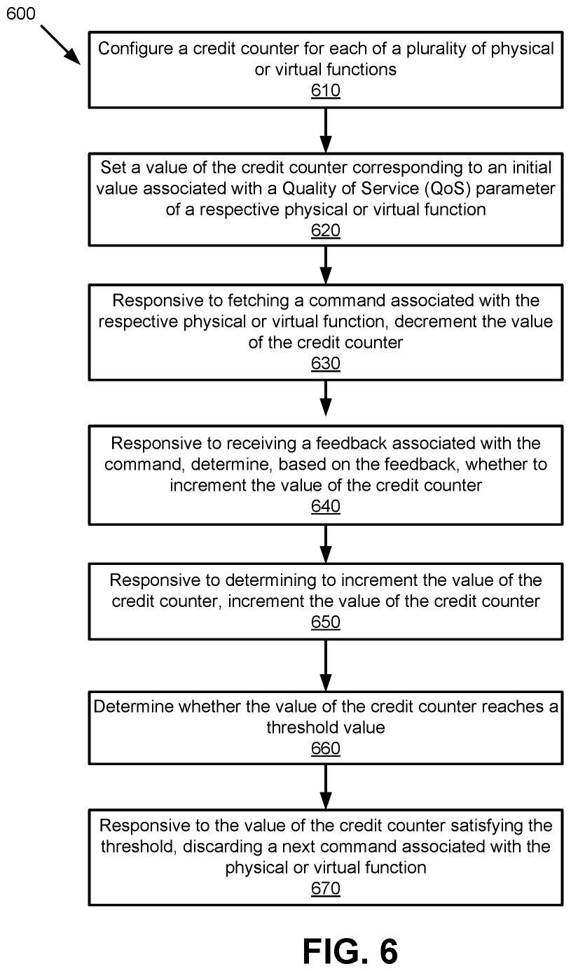

FIGS. 5-6 are flow diagrams of example methods 500-600 to manage QoS associated with each of multiple physical or virtual functions in a memory sub-system in accordance with some embodiments of the present disclosure. The methods 500-600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 500-600 are performed by the QoS management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 5, at operation 510, the processing device sets a value of a credit counter to an initial value of a Quality of Service (QoS) parameter of a physical or virtual function, wherein the physical or virtual function is one of a plurality of physical or virtual functions presented to a host computing system over a PCIe interface. At operation 520, the processing logic fetches a command from a host computing system associated with the physical or virtual function. At operation 530, the processing logic, responsive to fetching the command, decrements the value of the credit counter. At operation 540, the processing logic receives a reintroduced command associated with the physical or virtual function. At operation 550, the processing logic, responsive to receiving the reintroduced command, increments the value of the credit counter. At operation 560, the processing logic determines whether the value of the credit counter reaches a threshold value. At operation 570, the processing logic, responsive to that the value of the credit counter reaches the threshold value, stops fetching a future command associated with the physical or virtual function.

Referring to FIG. 6, at operation 610, the processing device configures a credit counter for each of a plurality of physical or virtual functions (PFs/VFs). At operation 620, the processing logic sets a value of the credit counter corresponding to an initial value associated with a Quality of Service (QoS) parameter of a respective physical or virtual function. At operation 630, the processing logic, responsive to fetching a command associated with the respective physical or virtual function, decrements the value of the credit counter. At operation 640, the processing, responsive to receiving a feedback associated with the command, determines, based on the feedback, whether to increment the value of the credit counter. At operation 650, the processing logic, responsive to determining to increment the value of the credit counter, increments the value of the credit counter. At operation 660, the processing logic determines whether the value of the credit counter reaches a threshold value. At operation 670, the processing logic, responsive to determining that the value of the credit counter reaches the threshold value, stops fetching a future command associated with the physical or virtual function.

In methods 500 and 600, the single physical or virtual function can be replaced with a set of physical or virtual functions, that is, a credit counter can be configured to the set of physical functions. Similarly, the queue, in a single or plurality form can used to replace the single physical or virtual function in methods 500 and 600.

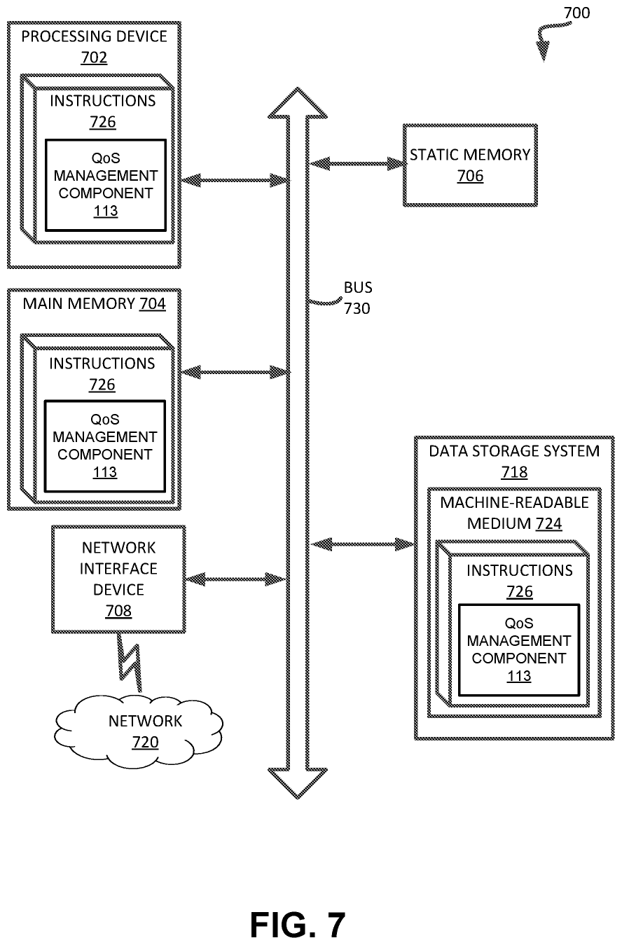

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the QoS management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a caching component (e.g., the QoS management component 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory system comprising:
a memory device;
a processing device coupled to the memory device, the processing device to:
present a plurality of physical or virtual functions (PFs/VFs) to a host computing system;
set, for each of the plurality of PFs/VFs, a value of a credit counter to an initial value associated with a Quality of Service (QoS) parameter of a respective PF/VF;
responsive to fetching an original command received from the host computing system associated with a specified PF/VF, decrement the value of the credit counter associated with the specified PF/VF;
responsive to receiving a reintroduced command associated with the specified PF/VF after the original command, increment the value of the credit counter;
determine whether the value of the credit counter is not higher than a threshold value; and
responsive to determining that the value of the credit counter is higher than the threshold value, continue fetching subsequent commands associated with the specified PF/VF.

2. The memory system of claim 1, wherein the initial value associated with the QoS parameter reflects a maximum value of the QoS parameter allowed for the specified PF/VF.

3. The memory system of claim 1, wherein the initial value is determined by a firmware component.

4. The memory system of claim 1, wherein the reintroduced command is received from a firmware component.

5. The memory system of claim 1, wherein the value of the credit counter is decremented by a value determined based on a size of the QoS parameter that the original command requires.

6. The memory system of claim 1, wherein the value of the credit counter is incremented by a value determined based on a size of the QoS parameter that the reintroduced command requires.

7. The memory system of claim 1, wherein the value of the credit counter is set to the initial value at a beginning of a time window.

8. The memory system of claim 1, wherein the processing device is further to:
responsive to determining that the value of the credit counter is not higher than the threshold value, stop fetching the subsequent commands associated with the specified PF/VF.

9. The memory system of claim 1, wherein the processing device is further to:
receive a specific value from a firmware component; and
set the value of the credit counter to the specific value.

10. The memory system of claim 1, wherein the processing device is further to:
periodically reset the value of the credit counter to the initial value.

11. A method, comprising:
presenting, by a processing device, a plurality of physical or virtual functions (PFs/VFs) to a host computing system over an interface, and
setting, for each of the plurality of PFs/VFs, a value of a credit counter to an initial value associated with a Quality of Service (QoS) parameter of a respective PF/VF;
responsive to fetching an original command received from the host computing system associated with a specified PF/VF, decrementing the value of the credit counter associated with the specified PF/VF;
responsive to receiving a reintroduced command associated with the specified PF/VF after the original command, incrementing the value of the credit counter;
determining whether the value of the credit counter reaches a threshold value; and
responsive to determining that the value of the credit counter reaches the threshold value, stopping fetching a subsequent command associated with the specified PF/VF.

12. The method of claim 11, wherein the initial value associated with the QoS parameter reflects a maximum value of the QoS parameter allowed for the specified PF/VF.

13. The method of claim 11, wherein the value of the credit counter is decremented by a value determined based on a size of the QoS parameter that the original command requires.

14. The method of claim 11, wherein the value of the credit counter is incremented by a value determined based on a size of the QoS parameter that the reintroduced command requires.

15. The method of claim 11, wherein the value of the credit counter is set to the initial value at a beginning of a time window.

16. The method of claim 11, further comprising: responsive to determining that the value of the credit counter does not reach the threshold value, continuing or resuming fetching the subsequent command associated with the specified PF/VF.

17. A non-transitory computer readable medium comprising instructions, which when executed by a processor, cause the processor to perform operations comprising:
configuring a credit counter for each of a plurality of physical or virtual functions (PFs/VFs) implemented by a memory sub-system comprising a plurality of memory devices;
setting a value of the credit counter corresponding to an initial value associated with a Quality of Service (QoS) parameter of a respective physical or virtual function;
responsive to fetching a command associated with a specific physical or virtual function, decrementing the value of the credit counter;
responsive to receiving a feedback associated with the specific physical or virtual function, determining, based on the feedback, whether to increment the value of the credit counter;
responsive to determining to increment the value of the credit counter, incrementing the value of the credit counter;
determining whether the value of the credit counter satisfies a threshold value; and
responsive to the value of the credit counter satisfying the threshold value, stop fetching a subsequent command associated with the specific PF/VF.

18. The method of claim 17, wherein the initial value associated with the QoS parameter reflects a maximum value of the QoS parameter allowed for the specific PF/VF.

19. The method of claim 17, wherein the value of the credit counter is decremented by a value determined based on a size of the QoS parameter that the command requires.

20. The method of claim 17, wherein the value of the credit counter is incremented by a value determined based on a size of the QoS parameter that a reintroduced command included in the feedback requires.
